(19) United States
(12) Patent Application Publication
(10) Pub. No.: US 2026/0152226 A1
(43) Pub. Date: Jun. 4, 2026

(54) IMPROVED SUPPORT STRUCTURE FOR A STEERING MEMBER

(71) Applicant: POCLAIN HYDRAULICS INDUSTRIE, Verberie (FR)

(72) Inventor: Clément Philippe Recoura, Verberie (FR)

(73) Assignee: POCLAIN HYDRAULICS INDUSTRIE, Verberie (FR)

(21) Appl. No.: 19/126,449

(22) PCT Filed: Oct. 26, 2023
(86) PCT No.: PCT/FR2023/051690

§ 371 Date: May 1, 2025

(30) Foreign Application Priority Data
Nov. 7, 2022 (FR) FR2211548

(51) Int. Cl. B62D 5/06

(52) U.S. Cl. CPC B62D 5/062

(57) ABSTRACT

A support frame for a hydraulic machine, the frame comprising:
a base, adapted to be assembled on a chassis, the base having an inner face and an outer face,
two arms extending from a proximal end and a distal end of the inner face of the base, the arms being spaced apart and each having a through-recess aligned along a pivot axis (Z-Z) so as to define a housing adapted to receive a hydraulic machine rotatably mounted along the pivot axis (Z-Z) relative to the frame,

the frame has a through-channel arranged in each of the arms, between the recess and the base, the base having a slot formed in its inner face, so as to form a continuous cable passage with the channels.

### TECHNICAL FIELD The present invention relates to the field of hydraulic machine supports for steering members.

### PRIOR ART

Hydraulic machines are commonly used for various applications, for example to drive in rotation members for the travel of vehicles or crafts, in particular steering members.

In the case where the hydraulic machine drives a steering member, problems related to the passage of cables and lines to the rotating connection between the hydraulic machine and a chassis then arise. Particularly, the guiding of the cables poses problems related to the protection of the cables on the one hand, and their accessibility on the other hand. Particularly, the cables must be protected from friction with objects and plants on a vehicle while it is moving, especially for agricultural vehicles, and must also be protected from knocks, pinching and tearing during transport and mounting of the hydraulic machine on a vehicle.

Particularly, the cables must be protected during handling of the steering assembly including the hydraulic machine, both for the mounting of the machine and for the operations of maintenance of the steering member, and must allow for a safe and easy electrical connection. The cables must also be easily accessible for maintenance.

The present invention aims to address these problems at least partially.

### Disclosure of the Invention

The present invention thus proposes a support frame for a hydraulic machine, the frame comprising:
a base, adapted to be assembled on a chassis, the base having an inner face and an outer face,
two arms extending from a proximal end and a distal end of the inner face of the base, said arms being spaced apart and each having a through-recess aligned along a pivot axis so as to define a housing adapted to receive a hydraulic machine rotatably mounted along the pivot axis relative to the frame, the frame being characterized in that it comprises a through-channel arranged in each of said arms, between the recess and the base, the base having a slot formed in its inner face, so as to form a continuous cable passage with the channels.

According to one example, each arm has an inner face and an outer face, the inner face being oriented towards the housing, and the outer face being opposite to the inner face, each channel arranged in the arms passing between the inner face and the outer face.

According to one example, the base comprises two segments on either side of the slot, said segments defining a volume internal to the base forming a cable passage.

According to one example, at least one of said segments of the base comprises grooves adapted to allow a passage of clamping elements (350) around said at least one segment.

According to one example, each of the arms comprises a recess extending in the extension of the slot of the base, said recesses defining portions of reduced thickness of the arms, the bores being formed in said recesses.

The present invention also relates to an assembly comprising a frame as defined above and a cable, said cable passing through the frame by passing in an internal volume of the frame, the cable successively passing through one channel, the slot and the other channel.

According to one example, said assembly comprises clamping elements adapted to hold the cable in position in the slot of the base.

According to one example, the cable has a portion internal to the frame comprised between the two channels of the arms, and a portion external to the frame, the portion internal to the frame being disposed in a shell delimited between the inner face and the outer face of the frame.

According to one example, said assembly further comprises a cap adapted to wrap one end of the cable opening out from a channel on an outer face of an arm.

### BRIEF DESCRIPTION OF THE DRAWINGS

The invention and its advantages will be better understood upon reading the detailed description given below of various embodiments of the invention given as non-limiting examples.

FIG. 1 shows an overall view of a hydraulic machine coupled to a frame.

FIG. 2 is a view of the frame.

FIG. 3 is a sectional view of the frame.

FIG. 4 is another view illustrating the cap mounted on the frame.

FIG. 5 is an exploded view of FIG. 4.

Throughout the figures, the elements in common are identified by identical reference numerals.

### DESCRIPTION OF THE EMBODIMENTS

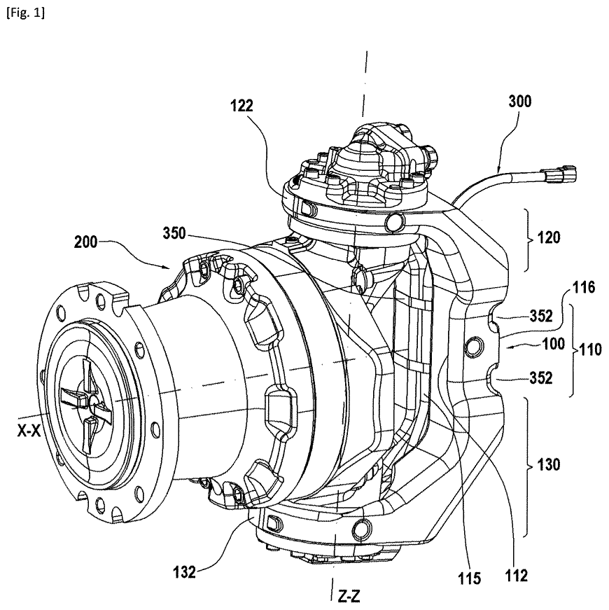

One example of frame and assembly according to one aspect of the invention is described below with reference to FIGS. 1 to 3.

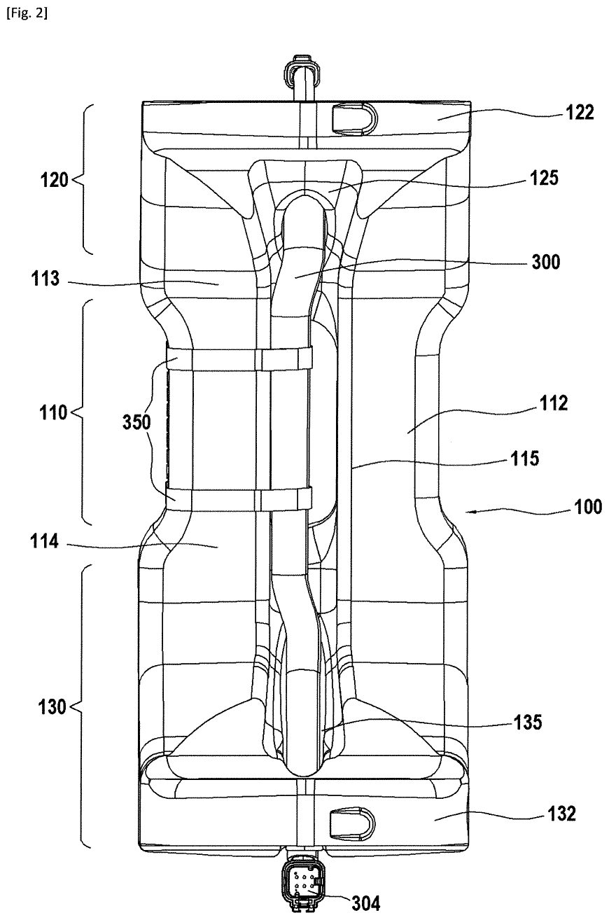

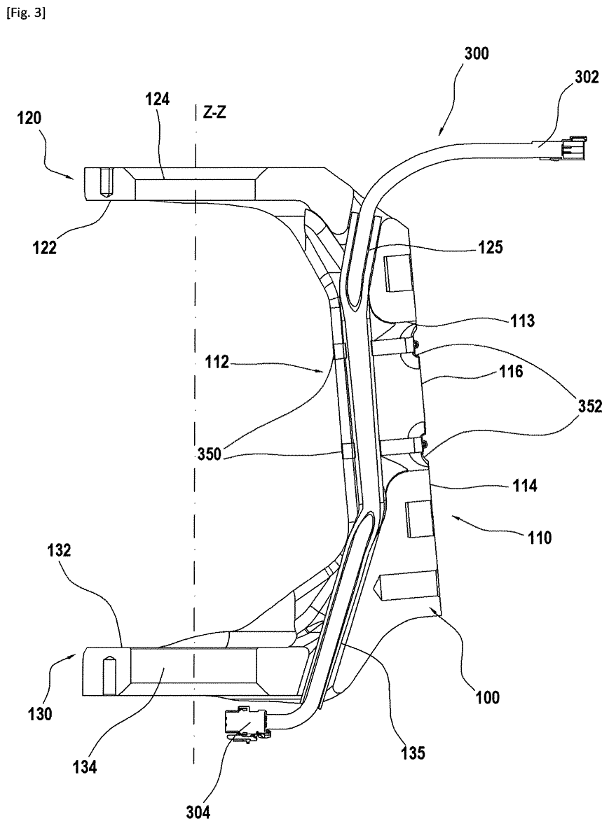

FIG. 1 shows one embodiment of an assembly that can be used in particular for driving a steering member of a vehicle or a craft. FIGS. 2 and 3 show specific views to illustrate the structure.

FIG. 1 represents a frame 100 forming a support for a hydraulic machine 200.

The hydraulic machine 200 is typically a radial-piston or axial-piston hydraulic machine, and has a first assembly and a second assembly movable in rotation relative to each other along an axial direction X-X, typically corresponding to an axis of a shaft of the hydraulic machine 200.

The frame 100 forms a support making it possible to define a pivot axis Z-Z between the hydraulic machine 200 and the frame 100. The frame 100 is typically assembled on a chassis; the pivot axis Z-Z thus makes it possible to define the orientation of a member driven in rotation by the hydraulic machine 200.

The pivot axis Z-Z is typically perpendicular to the axial direction X-X of the hydraulic machine 200, or inclined at an angle comprised between 60 and 90° relative to the axial direction X-X of the hydraulic machine 200.

The frame 100 as shown comprises a base 110 and two arms 120 and 130 extending from the base 110.

The base 110 as represented has a general plate shape, and has an inner face 112 and an outer face 116. The inner face 112 corresponds to a face of the base 110 oriented towards the hydraulic machine 200, while the outer face 116 is typically adapted to be secured to a support or chassis. It is understood that the outer face 116 more generally designates a portion of the base 110 opposite to the inner face 112 and adapted to be secured to a support or chassis.

A proximal end 113 and a distal end 114 are defined for the inner face 112 of the base 110. The designations “proximal” and “distal” are arbitrary here, and are intended only to distinguish two ends of the base 110. The two arms 120 and 130 extend respectively from the proximal end 113 and the distal end 114 of the inner face 112 of the base 110. The two arms 120 and 130 may thus be designated as being respectively the proximal arm 120 and the distal arm 130, these designations also being arbitrary and for illustrative purposes.

The two arms 120 and 130 extend so as to define two supports respectively 122 and 132 parallel to each other. These two supports 122 and 132 are spaced apart so as to define a housing adapted to receive the hydraulic machine 200.

The two supports 122 and 132 each have a through-recess, respectively 124 and 134, defining the pivot axis Z-Z.

Such a frame 100 is typically designated as a C-frame.

As indicated in the preamble, a problem for such elements concerns the passage of cables, in particular for electrical connectors or cables.

In the assembly as proposed, the frame 100 has a structure adapted for the passage of such cables.

The figures represent one example of a cable, designated by the reference numeral 300; which designates for example an electrical cable. Such a cable can be used for different functions, for example to connect electrical sensors, such as position or rotation speed sensors of the hydraulic machine, or pivot angle sensors, or other sensors such as flow rate or pressure. There may also be control or command electrical cables, for example an electrical command for changing the displacement of the hydraulic machine. The electrical cable may contain a plurality of electrical conductors for these different functions.

The cable 300 as shown passes through the frame 100. The cable 300 passes through the two arms 120 and 130, and passes in a slot formed in the base 110.

Each arm 120 and 130 comprises a channel, respectively 125 and 135, passing through the considered arm. For each arm 120 and 130, an inner face and an outer face are defined. The inner face of an arm is the face oriented towards the other arm and therefore the face oriented towards the housing adapted to receive the hydraulic machine 200. The two inner faces of the arms 120 and 130 are therefore oriented towards each other. The outer faces of the arms are opposite to the inner faces.

Each arm 120 and 130 therefore has a through-channel 125 or 135, between its inner face and its outer face, dimensioned so as to allow the passage of the cable 300. The channels 125 and 135 are typically bores that open out from the inner face of each of the arms 120 and 130. The channels 125 and 135 can be made by machining, or form an integral part with the frame 100.

The channels 125 and 135 open out facing the inner face 112 of the base 110. The base 110 as shown comprises a slot 115 or a groove extending from its proximal end 113 to its distal end 114, and thus forming a continuous passage between the channels 125 and 135 within the base 110.

The cable 300 can thus pass through the frame 100 by following a path that passes through a first channel 125 from the outer face to the inner face of the arm 120, then passes into the slot 115 of the base 110, and then passes through the second channel 135 from the inner face to the outer face of the arm 130. It is understood that the direction of travel has no impact; the reverse path is also possible, it is understood that the direction of installation leads to an identical result.

More generally, the cable has a first end 302 adapted to be connected to a connector secured to the chassis to which the frame 100 is fixed, and a second end 304 adapted to be connected to a connector covering one of the arms 120 or 130, here the arm 130 in the examples illustrated.

The arms 120 and 130 each typically have a recess extending in the extension of the slot 115 of the base 110. These recesses thus define portions of reduced thickness of the arms 120 and 130 in which the channels 125 and 135 are formed. The recesses and the slot 115 of the base 110 thus form a housing for the cable 300 in the volume of the frame 100, typically in such a way that the cable 300 does not protrude from the inner face 112 of the base 110 or the inner faces of the arms 120 and 130.

The cable 300 is thus housed within a volume defined by the geometry of the frame 100. In particular, if it is considered that the inner face 112 of the base 110 and the inner faces of the arms 120 and 130 define a shell around the geometry of the frame 100, the cable 300 is typically disposed inside this shell, and therefore inside the volume of the frame 100 relative to the inner face 112 of the base 110 and to the inner faces of the arms 120 and 130. Such a configuration thus makes it possible to protect the cable 300 against the risks of impacts and tearing via the structure of the frame 100, which is typically a casting.

Clamping elements 350 such as clamping collars are typically used to hold and guide the cable relative to the frame 100, and in particular within the slot 115 of the base 110. The base 110 as represented is in particular composed of two segments each extending between the proximal end 113 and the distal end 114. These two segments are spaced apart so as to form the slot 115 for the passage of the cable 300. In addition, each of the segments typically has grooves 352 formed on the outer face 116 of the base 110 for the passage of clamping elements 350, and in particular allowing the mounting and dismounting of the clamping elements 350 if the frame 100 is secured to a chassis or support, without requiring dismounting of the frame 100.

The proposed structure thus makes it possible to protect the cable 300 by means of the frame 100, while facilitating the operations of mounting and dismounting the cable 300 without requiring complete dismounting of the assembly.

The frame structure 100 as proposed is thus advantageous compared to the existing structures which provide for a cable passage either on the side of the frame 100, therefore exposed to impacts, or which provide for a passage of the cable at the interface between the frame 100 and the associated chassis, which therefore requires complete dismounting of the assembly for the replacement of the cable 300. It is noted that this frame structure makes it possible to protect the cable during the mounting, dismounting and transport of the frame 100 alone. The cable 300 nevertheless remains accessible and can be changed without dismounting the frame 100 from the machine.

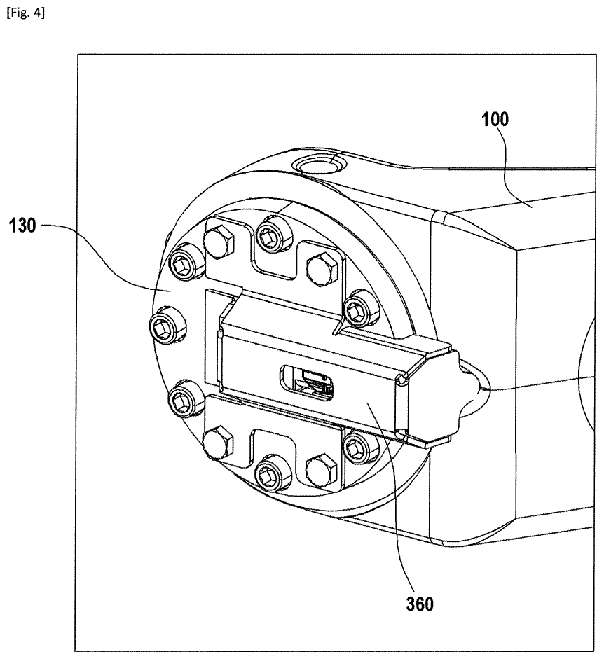

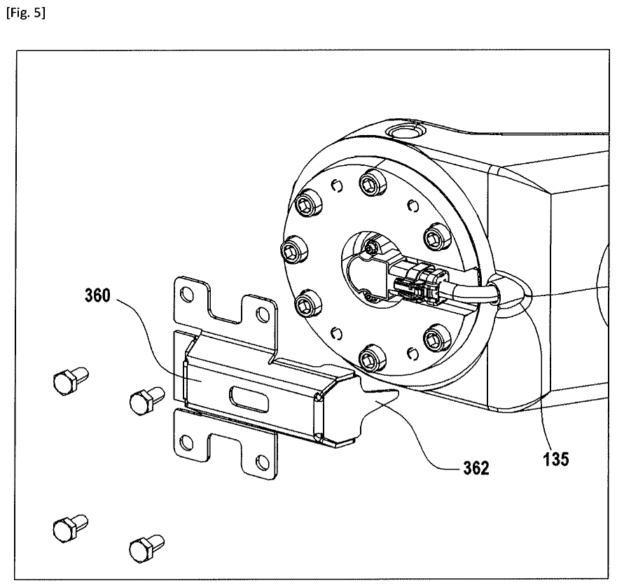

Optionally, the proposed system may comprise a cap 360 mounted on an outer face of the distal arm 130 at which the second end 304 of the cable 300 is located. FIGS. 4 and 5 show two views of such an embodiment.

These figures show a cap which covers the second end 304 of the cable 300, and where appropriate an associated connector. The cap 360 as represented is screwed onto the distal arm 130. The cap 360 has a bend shape, comprising a tab 362 adapted to partially penetrate into the channel 135 and thus perform a function of guiding and protecting the cable 300 from the channel 135 to its second end 304.

### The Cap 360 Is Typically Made of Plastic or Metal.

Although the present invention has been described with reference to specific exemplary embodiments, it is obvious that modifications and changes may be made to these examples without departing from the general scope of the invention as defined by the claims. Particularly, individual characteristics of the various illustrated/mentioned embodiments may be combined in additional embodiments. Consequently, the description and the drawings should be considered in an illustrative rather than restrictive sense.

It is also obvious that all the characteristics described with reference to one method are transposable, alone or in combination, to one device, and conversely, all the characteristics described with reference to one device are transposable, alone or in combination, to one method.

1. A support frame for a hydraulic machine, the frame comprising:
a base, adapted to be assembled on a chassis, the base having an inner face and an outer face,
two arms extending from a proximal end and a distal end of the inner face of the base, said arms being spaced apart and each having a through-recess aligned along a pivot axis so as to define a housing adapted to receive a hydraulic machine rotatably mounted along the pivot axis relative to the frame,
wherein the frame comprises a through-channel arranged in each of said arms, between the recess and the base, the base having a slot formed in its inner face, so as to form a continuous cable passage with the channels.

2. The frame according to claim 1, wherein each arm has an inner face and an outer face, the inner face being oriented towards the housing, and the outer face being opposite to the inner face, each channel arranged in the arms passing between the inner face and the outer face.

3. The frame according to of claims 1, wherein the base comprises two segments on either side of the slot, said segments defining a volume internal to the base forming a cable passage.

4. The frame according to claim 3, wherein at least one of said segments of the base comprises grooves adapted to allow a passage of clamping elements around said at least one segment.

5. The frame according to claim 3, wherein each of the arms comprises a recess extending in the extension of the slot of the base, said recesses defining portions of reduced thickness of the arms, the bores being formed in said recesses.

6. An assembly comprising a frame according to claim 1 and a cable, said cable passing through the frame by passing in an internal volume of the frame, the cable successively passing through one channel, the slot and the other channel.

7. The assembly according to claim 6, comprising clamping elements adapted to hold the cable in position in the slot of the base.

8. The assembly according to claim 6, wherein the cable has a portion internal to the frame comprised between the two channels of the arms, and a portion external to the frame, the portion internal to the frame being disposed in a shell delimited between the inner face and the outer face of the frame.

9. The assembly according to claim 7, further comprising a cap adapted to wrap one end of the cable opening out from a channel on an outer face of an arm.
